(19) United States
(12) Patent Application Publication
(10) Pub. No.: US 2011/0195258 A1
(43) Pub. Date: Aug. 11, 2011

(54) Microencapsulated liquid device and method for making the same

(75) Inventors: Shih-Kang Fan, Hsinchu (TW); Cheng-Pu Chiu, Zhonghe City (TW); Ching-Hsiang Hsu, Hsinchu City (TW)

(73) Assignee: NATIONAL CHIAO TUNG UNIVERSITY, Hsinchu (TW)

(21) Appl. No.: 12/805,546

(22) Filed: Aug. 5, 2010

(30) Foreign Application Priority Data
Feb. 11, 2010 (TW) 099104384

(51) Int. Cl. B32B 27/32; B32B 9/00; B65B 3/02

(52) U.S. Cl. 428/447; 428/523; 53/452

(57) ABSTRACT

A microencapsulated liquid device includes: a substrate; a droplet liquid disposed on the substrate; a protecting layer covering the droplet liquid, the protecting layer being made from an encapsulating liquid that is immiscible with the droplet liquid, that has a surface energy lower than that of the droplet liquid, and that is solidified to form the protecting layer; and a cover plate covering the protecting layer. A method for making the microencapsulated liquid device is also disclosed.

### CROSS-REFERENCE TO RELATED APPLICATION

This application claims priority of Taiwanese application no. 099104384, filed on Feb. 11, 2010.

### BACKGROUND OF THE INVENTION

1. Field of the Invention

This invention relates to a microencapsulated liquid device and a method for making the same.

2. Description of the Related Art

A microencapsulated liquid device, such as those used in a varifocal encapsulated liquid lens, an electrowetting device, an electronic paper, a microfluidic system, a biosensor chip, etc., generally uses water or an aqueous solution that is conductive as an essential droplet liquid. However, water or the aqueous solution is evaporated easily and is hard to stay packaged in the microencapsulated liquid device. Thus, such microencapsulated liquid device has a relatively short service life. In the prior art, in order to package water or the aqueous solution in the microencapsulated liquid device, another liquid that is immiscible with water or the aqueous solution is used to fill in the microencapsulated liquid device to form a layer impermeable to air on water or the aqueous solution. However, such packaging method is difficult to perform using standard microfabrication techniques.

A varifocal encapsulated liquid lens described in APPLIED PHYSICS LETTERS 93, 124101 (2008) is shown in FIG. 1 and can function as a display unit. The varifocal encapsulated liquid lens includes a glass wafer 10 formed with a lower electrode layer 20 thereon, a liquophobic layer 40 formed on the glass wafer 10 and peripherally covering the lower electrode 20, an oily droplet liquid 30 dropped on a region of the lower electrode 20 uncovered by the liquophobic layer 40, a protecting layer 50 made of parylene and deposited on the oily droplet liquid 30 and the liquophobic layer 40, and an upper electrode layer 60 formed on the protecting layer 50. In this case, the oily droplet liquid 30 is packaged in the varifocal encapsulated liquid lens by directly forming the protecting layer 50 of parylene on the droplet liquid 30 using chemical vapor deposition. Since parylene cannot be formed directly on water or the aqueous solution, such technology cannot be used in the microencapsulated liquid device with the aqueous droplet liquid packaged therein. Besides, the formation of the protecting layer 50 is carried out by the chemical vapor deposition in vacuum and thus, is relatively complicated.

A display unit disclosed in U.S. Pat. No. 6,672,921 is made by filling each of an array of micro-cups with a pigment dispersion (i.e., a droplet liquid) including a dielectric solvent, pigment particles and a thermoset precursor, followed by curing the thermoset precursor to form a supernatant layer on top of the liquid phase. Since the thermoset precursor is immiscible with the dielectric solvent and has a specific gravity lower than the dielectric solvent and the pigment particles, the pigment particles and the solvent in each micro-cup can be sealed by the supernatant layer. However, in practice, it is necessary to ascertain whether or not the thermoset precursor floats on and is completely separated from the dielectric solvent and the pigment particles before curing the thermoset precursor. Accordingly, the display unit made by the aforesaid method is relatively complicated, and thus, the quality of the same is hard to control.

### SUMMARY OF THE INVENTION

Therefore, an object of the present invention is to provide a microencapsulated liquid device and a method for making the same that can overcome the aforesaid drawbacks associated with the prior art. Especially, the microencapsulated liquid device has a relatively long service life and includes a droplet liquid that can be stably packaged therein.

According to one aspect of the present invention, there is provided a microencapsulated liquid device comprising:

a substrate;

a droplet liquid disposed on the substrate;

a protecting layer covering the droplet liquid, the protecting layer being made from an encapsulating liquid that is immiscible with the droplet liquid, that has a surface energy lower than that of the droplet liquid, and that is solidified to form the protecting layer; and

a cover plate covering the protecting layer.

According to another aspect of the present invention, there is provided a method for making a microencapsulated liquid device, comprising:

(a) forming a substrate having a microchamber surrounded by a microchamber wall;

(b) filling a droplet liquid in the microchamber;

(c) filling an encapsulating liquid in the microchamber above the droplet liquid to cover the droplet liquid, the encapsulating liquid being immiscible with the droplet liquid and having a surface energy lower than that of the droplet liquid;

(d) disposing a cover plate on the microchamber; and

(e) solidifying the encapsulating liquid to form a protecting layer.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic diagram of a conventional varifocal encapsulated liquid lens;

FIG. 2 is a schematic diagram of the first preferred embodiment of a microencapsulated liquid device according to the present invention;

FIG. 3 is a schematic diagram of the second preferred embodiment of a microencapsulated liquid device according to the present invention; and

FIG. 4 is a schematic diagram for illustrating consecutive steps of the preferred embodiment of a method for making a microencapsulated liquid device according to the present invention.

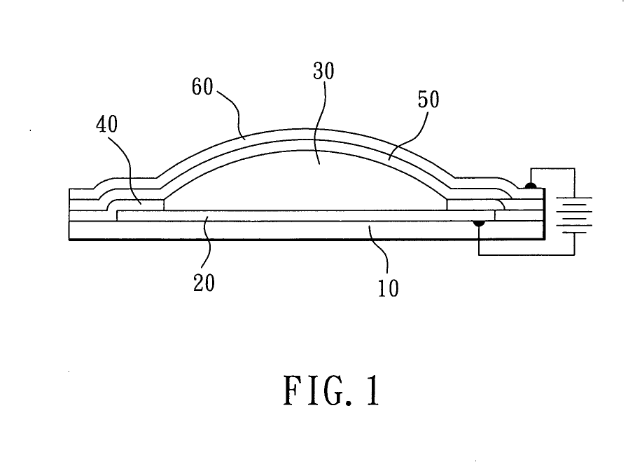

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

The term “microencapsulated liquid device” used in the context means a micro device with a droplet liquid packaged therein. When the microencapsulated liquid device is utilized in the varifocal encapsulated liquid lens, the electrowetting device, the electronic paper, the microfluidic system, the biosensor chip, etc., it can serve as a display unit.

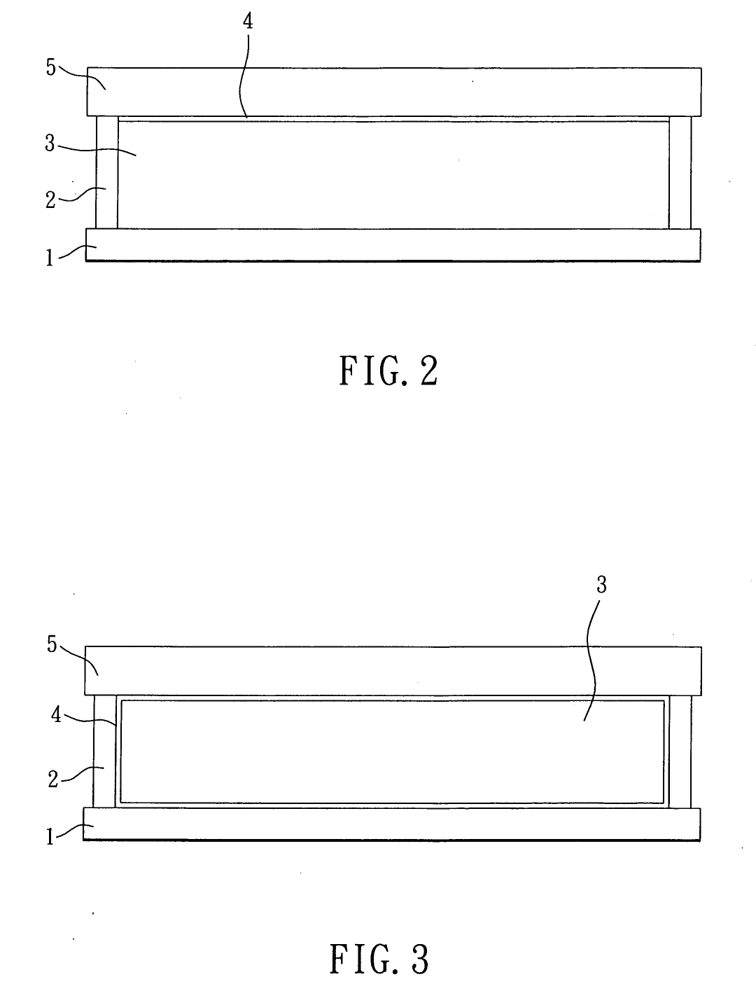

Referring to FIGS. 2 and 3, a microencapsulated liquid device of the present invention includes a substrate 1 having a microchamber surrounded by a microchamber wall 2 formed on the substrate 1, a droplet liquid 3 filled in the microchamber, a protecting layer 4 covering the droplet liquid 3, and a cover plate 5 covering the protecting layer 4.

The substrate 1 is made of a hydrophobic material. The microchamber wall 2 is formed on the substrate 1 by one of the known methods. The droplet liquid 3 is an aqueous liquid. Preferably, the droplet liquid 3 includes an aqueous solution of polystyrene beads.

The arrangement of the protecting layer 4 should not adversely affect the performance of the droplet liquid 3. For example, when the protecting layer 4 is used in the varifocal encapsulated liquid lens or the electrowetting device, the protecting layer 4 should not adversely affect the electrowetting property of the droplet liquid 3 (i.e., the variation of the contact angle due to the applied voltage). When the protecting layer is used in an electrowetting-on-dielectric device including the droplet liquid composed of oil-phase and water-phase components, in which the water-phase component in the droplet liquid 3 will move with variation of the applied voltage, the protecting layer 4 should not adversely affect the movement of the water-phase component of the droplet liquid 3.

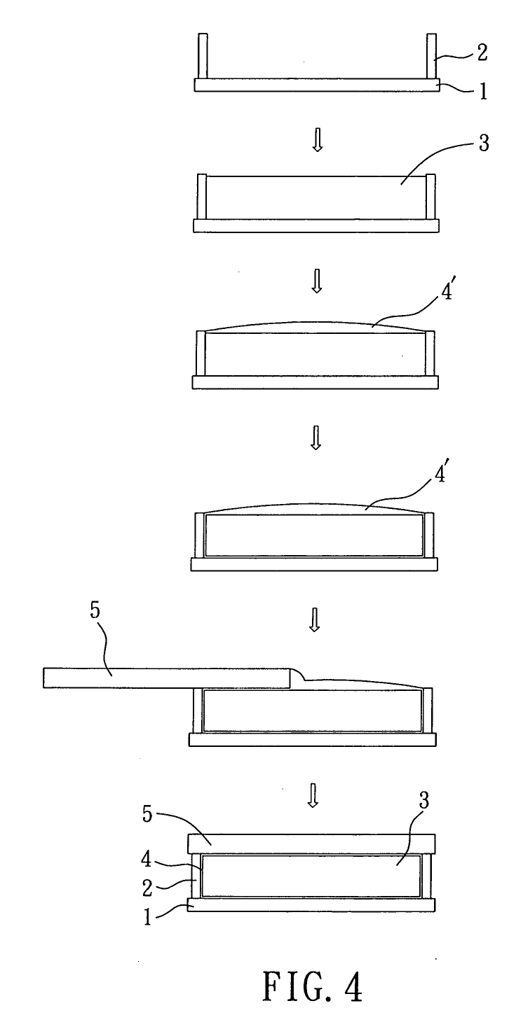

The protecting layer 4 is made from an encapsulating liquid 4′ (see FIG. 4). The encapsulating liquid 4′ is immiscible with the droplet liquid 3, has a surface energy lower than that of the droplet liquid 3, and is solidified to form the protecting layer 4. Preferably, the encapsulating liquid 4′ is an oily liquid.

In the first embodiment of this invention as shown in FIG. 2, the protecting layer 4 covers the droplet liquid 3. In the second embodiment of this invention as shown in FIG. 3, the protecting layer 4 encapsulates the droplet liquid 3. It should be noted that composition of the encapsulating liquid 4′ and constitutional ratio or amount of each constituting component thereof is adjustable according to the intended use so that the resulting protecting layer will have the required thickness and mechanical properties (e.g. elasticity), as long as the protecting layer 4 will not affect the performance of the droplet liquid 3.

The encapsulating liquid 4′ includes a curable polymer composition and a solvent to dissolve the curable polymer composition. Preferably, the polymer composition includes a crosslinkable material and a crosslinking agent. Examples of the crosslinkable material include, but are not limited to, monomers, oligomers, and polymers. The cross-linking agent can be selected from commercial products based on the selected species of the crosslinkable material. In the Examples of the present invention, the curable polymer composition includes polydimethylsiloxane (PDMS).

The solvent of the encapsulating liquid 4′ is used to adjust the viscosity and the surface energy of the encapsulating liquid 4′, and is immiscible with the droplet liquid 3. Preferably, the solvent is a hydrophobic solvent. Examples of the solvent include, but are not limited to, hexane, silicone oil, etc. In the examples of the present invention, the solvent is hexane.

In the encapsulating liquid 4′, the weight ratio of the solvent to the curable polymer composition should be adjusted and varied so as to meet the following requirements: (1) the surface energy of the encapsulating liquid 4′ is lower that that of the droplet liquid 3; (2) the encapsulating liquid 4′ is able to cover or even to encapsulate the droplet liquid 3; and (3) the encapsulating liquid 4′ is able to be solidified. In the examples of the present invention, the weight ratio of the solvent to the curable polymer composition is 15:1.

Constructional elements of the substrate 1 and the cover plate 5 can be adjusted and varied according to the intended application of the microencapsulated liquid device.

Preferably, the cover plate 5 includes a gas barrier film (not shown) that may be made of, but not limited to, a hydrophobic material. For example, the gas barrier film is made of parylene. In some cases, each of the substrate 1 and the cover plate 5 includes at least one electrode (not shown). That is to say, the cover plate 5 may include both of the gas barrier film and a conductive or metallic layer (i.e., an electrode layer), or may be only composed of the gas barrier film.

Referring to FIG. 4, a method for making a microencapsulated liquid device of the present invention includes: (a) forming the substrate 1 having the microchamber surrounded by the microchamber wall 2; (b) filling the droplet liquid 3 in the microchamber; (c) filling the encapsulating liquid 4′ in the microchamber above the droplet liquid 3; (d) disposing the cover plate on the microchamber; and (e) solidifying the encapsulating liquid 4′ to form the protecting layer 4.

As shown in FIG. 4, the liquid droplet 3 has a height lower than that of the microchamber wall 2 after the step (b), and the encapsulating liquid 4′ has a surface higher than that of the microchamber wall 2 after the step (c). In the step (d), the excess encapsulating liquid 4′ is removed by moving the cover plate 5 over the microchamber wall 2.

Since the size of the microchamber is likely to get smaller and smaller with the progress of display technologies, and since the substrate 1 and the microchamber wall 2 are preferably made of hydrophobic material, the filling of the droplet liquid 3 is expected to get more and more difficult. Therefore, after the step (a), the method preferably further includes: (a1) applying a surface treatment to interior surfaces of the microchamber defined by the microchamber wall 2 and the substrate 1 to provide hydrophilic surfaces adapted to contact the droplet liquid 3. Preferably, the surface treatment is oxygen plasma treatment. By way of the oxygen plasma treatment, the interior surfaces of the microchamber defined by the microchamber wall 2 and the substrate 1 can be temporarily rendered hydrophilic to facilitate the droplet liquid 3 to intimately fill in the microchamber.

In general, after the step (c), the encapsulating liquid 4′ will enter the clearance between the microchamber wall 2 and the droplet liquid 3 to encapsulate the droplet liquid 3 since it has the surface energy lower than that of the droplet liquid 3, and the microencapsulated liquid device formed is that shown in FIG. 3. However, when there is no clearance between the microchamber wall 2 and the droplet liquid 3, the encapsulating liquid 4′ only covers the portion of the droplet liquid 3 exposed to the outside before the step (c), and the microencapsulated liquid device formed is that shown in FIG. 2. By the way, whether the clearance between the microchamber wall 2 and the droplet liquid 3 is formed or not is determined by the height of the droplet liquid 3 and the surface energy of the droplet liquid 3 and the encapsulating liquid 4.

In the step (e), the solidification of the protecting layer 4 is preferably conducted by thermal curing or photocuring of the encapsulating liquid 4′.

In addition, the step (d) may be conducted before or after the step (e). That is to say, the solidification of the protecting layer 4 may be conducted prior to the disposition of the cover plate 5. Preferably, before the step (d), the cover plate 5 is formed with the hydrophobic gas barrier film (not shown) thereon using chemical vapor deposition. In other preferred embodiments, the cover plate 5 may be made of a hydrophobic material and may be formed on the protecting layer 4 using chemical (or physical) vapor deposition.

The present invention is explained in more detail below by way of the following examples. It should be noted that the examples are only for illustration and not for limiting the scope of the present invention.

### Example 1

Referring to FIGS. 3 and 4, first of all, the substrate 1 having the microchamber surrounded by the microchamber wall 2 was provided, and an oxygen plasma treatment was applied to the interior surfaces of the microchamber defined by the microchamber wall 2 and the substrate 1. Then, the droplet liquid 3 including an aqueous solution of polystyrene beads was filled in the microchamber, and the encapsulating liquid 4′ including PDMS and hexane (hexane: PDMS=15:1) was filled in the microchamber above the droplet liquid 3 to encapsulate the droplet liquid 3. Thereafter, the cover plate 5 was moved over the microchamber wall 2 to remove the excess encapsulating liquid 4′. Finally, the above structure as a whole was heated at 40° C. for 5 minutes to solidify the encapsulating liquid 4′ and to form the protecting layer 4, thereby forming the microencapsulated liquid device.

### Example 2

The structure of the microencapsulated liquid device of Example 2 and the method for ma king the same are similar to those of Example 1, except that, in Example 2, after the droplet liquid 3 was encapsulated by the encapsulating liquid 4′, the whole structure was immediately heated at 40° C. for 5 minutes to form the protecting layer 4. Finally, the gas barrier film of parylene was then formed on the protecting layer 4 using chemical vapor deposition to serve as the cover plate 5.

In summary, by the present invention, the protecting layer 4 can be formed by a relatively simple way to cover and even to encapsulate the droplet liquid 3, and the droplet liquid 3, especially an aqueous liquid, can be stably packaged in the microencapsulated liquid device. Therefore, the microencapsulated liquid device of the present invention has a relatively long service life.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A microencapsulated liquid device comprising:
a substrate;
a droplet liquid disposed on said substrate;
a protecting layer covering said droplet liquid, said protecting layer being made from an encapsulating liquid that is immiscible with said droplet liquid, that has a surface energy lower than that of said droplet liquid, and that is solidified to form said protecting layer; and
a cover plate covering said protecting layer.

2. The microencapsulated liquid device of claim 1, wherein said droplet liquid is an aqueous liquid, said substrate is made of a hydrophobic material, and said encapsulating liquid is an oily liquid.

3. The microencapsulated liquid device of claim 1, wherein said encapsulating liquid includes a curable polymer composition and a solvent to dissolve said curable polymer composition.

4. The microencapsulated liquid device of claim 3, wherein said curable polymer composition includes a crosslinkable material and a cross-linking agent, said crosslinkable material being selected from the group consisting of monomers, oligomers, and polymers.

5. The microencapsulated liquid device of claim 3, wherein said curable polymer composition includes polydimethylsiloxane.

6. The microencapsulated liquid device of claim 5, wherein said solvent is hexane.

7. The microencapsulated liquid device of claim 2, wherein said droplet liquid includes an aqueous solution of polystyrene.

8. The microencapsulated liquid device of claim 1, wherein said cover plate includes a gas barrier film disposed on said protecting layer.

9. The microencapsulated liquid device of claim 8, wherein said gas barrier film is made of parylene.

10. A method for making a microencapsulated liquid device, comprising:
(a) forming a substrate having a microchamber surrounded by a microchamber wall;
(b) filling a droplet liquid in the microchamber;
(c) filling an encapsulating liquid in the microchamber above the droplet liquid to cover the droplet liquid, the encapsulating liquid being immiscible with the droplet liquid and having a surface energy lower than that of the droplet liquid;
(d) forming a cover plate on the microchamber; and
(e) solidifying the encapsulating liquid to form a protecting layer.

11. The method of claim 10, wherein the step (d) is conducted before or after the step (e).

12. The method of claim 10, wherein the droplet liquid is an aqueous liquid, the encapsulating liquid is an oily liquid, and the substrate is made of a hydrophobic material.

13. The method of claim 10, wherein the encapsulating liquid includes a polymer composition and a solvent for dissolving the polymer composition.

14. The method of claim 13, wherein the polymer composition includes polydimethylsiloxane.

15. The method of claim 14, wherein the solvent is hexane.

16. The method of claim 10, wherein, after the step (a), the method further comprises: (a1) applying a surface treatment to the substrate to render a surface of the substrate hydrophilic.

17. The method of claim 16, wherein the surface treatment is oxygen plasma treatment.

18. The method of claim 10, wherein the cover plate includes a gas barrier film disposed on said protecting layer.

19. The method of claim 18, wherein the gas barrier film is made of parylene.

20. The method of claim 10, wherein the droplet liquid has a height lower than that of the microchamber wall after being filled in the microchamber wall, and the encapsulating liquid has a surface higher than that of the microchamber wall after being filled in the microchamber.
